(19) United States
(12) Patent Application Publication
(10) Pub. No.: US 2005/0287312 A1
(43) Pub. Date: Dec. 29, 2005

(54) Ink jet printing media

(76) Inventor: Jayprakash Bhatt, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/879,249

(22) Filed: Jun. 28, 2004

(51) Int. Cl. B41M 5/00

(52) U.S. Cl. 428/32.34

(57) ABSTRACT

A method of producing a print medium with increased ozone fastness to reduce problems associated with the gradual dye-fade and color-shift of inks over time. Specifically, a method can comprise steps of coating a media substrate with a porous coating composition of metal or semi-metal oxide particulates to form a porous ink receiving layer, and coating the porous ink-receiving layer with an aqueous overcoat composition to form a discontinuous film. The discontinuous film can be configured with pores to allow an ink to be received at the porous ink-receiving layer. Additionally, the aqueous overcoat composition can comprise an amine, an amide, or combinations thereof; a latex; and a binder.

### FIELD OF THE INVENTION

The present invention relates generally to ink-jet media and methods for reducing the fading of printed images. More particularly, the present invention relates to preparing an ink-receiving layer with a discontinuous film overcoat containing an amine compound.

### BACKGROUND OF THE INVENTION

In ink-jet technology, image quality of high-resolution images can be a function of both the ink-jet ink used to produce an image, and the print medium upon which the image is printed. Desirable attributes of print quality include saturated colors, high gloss and gloss uniformity, and freedom of grain and coalescence, among other characteristics.

Once a high-resolution image is printed, however, another major issue arises, namely, image permanence relating to how long the quality of the image will last. As the photo industry continues to move from film to digital image methods, the issue of image permanence becomes much more important.

With respect to much of the print media currently on the market, printed images commonly have undesirable attributes in the area of image permanence. One such undesirable attribute is the gradual dye-fade observed when dye-based ink-jet inks are printed on porous media. Such fade has been shown to be caused by air, and more particularly, by small amounts of ozone in the air. It appears that, over time, ozone reacts with many dyes commonly used in ink-jet inks, thus causing them to break down and to lose or diminish their intended color properties. It should be noted that dye-fade is more of a problem with certain dyes than with others. For example, cyan dyes tend to be affected to a greater extent by the presence of ozone in the air than do other dyes.

Along with dye-fade, another significant undesirable attribute is color-shift. It has been observed that when ozone reacts with ink-jet ink dyes, the intended color properties of a given dye may shift to another wavelength value along the visible spectrum. This effect causes a gradual change in the perceived colors of the printed image from what was originally intended by the dyes.

Both of these undesirable attributes, dye-fade and color-shift, gradually affect the perception of the printed image. Because the printed image is susceptible to these significant changes over time, many have been reluctant, especially in the graphics arts and photography industries, to embrace ink-jet printing of images intended to last a significant period of time.

As such, it would be beneficial to develop print media that provided for increased ozone fastness and reduced color-shift for printed images, even when utilizing a wide variety of ink-jet inks and associated dyes.

### SUMMARY OF THE INVENTION

It has been recognized that it would be advantageous to develop a print medium with increased ozone fastness that reduces undesirable attributes related to image permanence, such as dye-fade and color-shift. In accordance with this recognition, a method of producing a print medium can comprise steps of coating a media substrate with a porous coating composition including metal oxide or semi-metal oxide particulates to form a porous ink receiving layer, and coating the porous ink-receiving layer with an aqueous overcoat composition to form a discontinuous film. The discontinuous film can be configured with pores to allow an ink to be received at the porous ink-receiving layer. The aqueous overcoat composition can comprise an amine, an amide, or combinations thereof; a latex; and a binder.

In accordance with an alternative detailed aspect of the present invention, a print medium designed to increase ozone fastness can include a media substrate, a porous ink-receiving layer coated on the media substrate, and a discontinuous film coated on the porous ink-receiving layer, where the discontinuous film is configured with pores to allow an ink to be received at the porous ink-receiving layer. The discontinuous film can include an amine, an amide, or combinations thereof; latex particulates; and a binder. Additionally, the ink-receiving layer can include metal or semi-metal oxide particulates.

In another aspect of the present invention, a printed image on a print medium exhibiting increased ozone fastness can include a media substrate, a porous ink-receiving layer coated on the media substrate, a discontinuous film coated on the porous ink-receiving layer, where the discontinuous film is configured with pores to allow an ink to be received at the porous ink-receiving layer, and an ink-jet ink printed on at least a portion of the discontinuous film and received by the porous ink-receiving layer. The discontinuous film can include an amine, an amide, or combinations thereof; latex particulates; and a binder. Also, the porous ink-receiving layer can include metal or semi-metal oxide particulates.

Additional features and advantages of the invention will be apparent from the following detailed description which illustrates, by way of example, features of the invention.

### DETAILED DESCRIPTION OF THE PREFERRED EMBODIMENT(S)

Before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

In describing and claiming the present invention, the following terminology will be used.

The singular forms “a,” “an,” and “the” include plural referents unless the context clearly dictates otherwise. Thus, for example, reference to “a dye” includes reference to one or more of such materials.

An “ink” or “ink-jet ink” refers to a liquid solution or dispersion composition that can comprise a liquid vehicle and a colorant, e.g., a dye. The liquid vehicle can be configured to be stable with the dye through a broad range of solution characteristics, and can be configured for ink-jet printing.

As used herein, “liquid vehicle” is defined to include liquid compositions that can be used to carry colorants to a substrate. Liquid vehicles are well known in the art, and a wide variety of ink vehicles may be used in accordance with embodiments of the present invention. Such ink vehicles may include a mixture of a variety of different agents, including without limitation, surfactants, solvents, cosolvents, buffers, biocides, viscosity modifiers, sequestering agents, stabilizing agents, and water. The liquid vehicle can also carry other additives such as polymers, UV curable materials, and/or plasticizers in some embodiments.

“Media substrate” or “substrate” includes any substrate that can be coated with a coating composition (to form an ink-receiving layer) of the present invention, and can include papers, overhead projector plastics or films, coated papers such as photobase, fabric, art paper such as water color paper, optical disks, or the like.

The term “print medium” or “print media” refers to a media substrate that is coated with an ink-receiving layer.

“Porous media” refers to any substantially inorganic particulate-containing coated media having surface voids and/or cavities capable of taking in the ink-jet inks in accordance with embodiments of the present invention. Typically, porous media includes a substrate and a porous ink-receiving layer. As ink is printed on the porous media, the ink can fill the voids and the outermost surface can become dry to the touch in a more expedited manner as compared to traditional or swellable media. Common inorganic particulates that can be present in the coatings include metal or semi-metal oxide particulates such as silica or alumina. Additionally, such coatings are typically bound together by a polymeric binder, and optionally, can include mordants or ionic binding species that are attractive of classes of predetermined dye species.

The term “latex” or “latex dispersion” includes both latex particulates as well as the aqueous medium in which the latex particulates are dispersed. More specifically, a latex is a liquid suspension comprising a liquid (such as water and/or other liquids) and polymeric particulates from 20 nm to 500 nm (preferably from 100 nm to 300 nm) in size, and having a weight average molecular weight from about 10,000 Mw to 2,000,000 Mw (preferably from about 40,000 Mw to 100,000 Mw). Typically, the polymeric particulate can be present in the liquid at from 0.5 wt % to 15 wt %. Such polymeric particulates can comprise a plurality of monomers that are typically randomly polymerized, and can also be crosslinked. When crosslinked, the molecular weight can be even higher than that cited above. Additionally, in one embodiment, the latex component can have a glass transition temperature from about −25° C. to 100° C.

The term “latex particulates” or “latex particles” are the polymeric masses that are dispersed in latex dispersion.

The term “glass transition temperature” refers to the temperature at which the properties of a polymer change from a rigid state to a more elastic state. In other words, a polymer is in a rigid state when the temperature is below the glass transition temperature for that polymer, and is in an elastic or flowable state when above the glass transition temperature. When heated above the glass transition temperature, latex particulates can begin to flow together to form a more continuous film.

The term “discontinuous film” refers to a particulate layer that comprises a matrix-like structure of latex particulates interspersed with voids. The voids are distributed throughout the layer, and are of such a size as to allow the passage of a fluid. An example of such a discontinuous film results from the application of a latex to a substrate at below the glass transition temperature for the latex particulates. This layer has not been heated to form a continuous film, and thus comprises a matrix of latex particulates with interspersed voids. The average size of the voids can be from about 5 nm to about 25 nm, though these values may be highly variable. These values can provide a good balance between porosity for receiving ink and acceptable image quality or gloss. Because the latex has not formed a continuous film, ink is allowed to pass through the voids upon application.

The term “polyamine” includes any amine having at least two amine functionalities.

The term “polyamide” includes any amide having at least two amide functionalities.

The term “about” when referring to a numerical value or range is intended to encompass the values resulting from experimental error that can occur when taking measurements.

Concentrations, amounts, measurements, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight range of about 1 wt % to about 20 wt % should be interpreted to include not only the explicitly recited concentration limits of 1 wt % to about 20 wt %, but also to include individual concentrations such as 2 wt %, 3 wt %, 4 wt %, and sub-ranges such as 5 wt % to 15 wt %, 10 wt % to 20 wt %, etc.

In accordance with various embodiments of the present invention, a method is disclosed for producing a print medium that results in a reduction of dye-fade and/or color-shift over time by increasing ozone fastness. The method can include a step of coating a media substrate with a porous coating composition, containing metal or semi-metal oxide particulates, to form a porous ink-receiving layer. The method can also include a step of coating the porous ink-receiving layer with an aqueous overcoat composition to form a discontinuous film that is configured with pores to allow an ink to be received at the porous ink-receiving layer. The aqueous overcoat composition can include an amine, an amide, or combinations thereof; a latex; and a binder.

The resulting print medium can demonstrate increased ozone fastness and thus greater durability to dye-fade, color-shift, and other ozone related reactions over time. The amines or amides in the discontinuous film are thought to interact with small amounts of ozone in the air, thus minimizing the reaction between the ozone and the ink received by the porous ink-receiving layer. The resulting increase in ozone fastness can reduce dye-fade and color-shift effects that appear over time on the surface of a printed image.

Another embodiment of the present invention provides a print medium that can increase ozone fastness. The print medium can comprise a porous ink-receiving layer coated on a media substrate, and a discontinuous film coated on the porous ink-receiving layer. The porous ink-receiving layer can include metal or semi-metal oxide particulates. Additionally, the discontinuous film is configured with pores to allow ink to be received at the porous ink-receiving layer, and can include an amine, an amide, or combinations thereof; latex particulates; and a binder.

In another embodiment, a printed image on a print medium is provided that can exhibit increased ozone fastness. The printed image can comprise a media substrate with a porous ink-receiving layer coated thereon, a discontinuous film coated on the porous ink-receiving layer, and an ink-jet ink printed on at least a portion of the discontinuous film, such that the ink is received by the porous ink-receiving layer. The porous ink-receiving layer can include metal or semi-metal oxide particulates. Additionally, the discontinuous film can include an amine, an amide, or combinations thereof; latex particulates; and a binder.

Porous Media Coatings

In accordance with aspects of the present invention, methods, coated print media, and printed images are provided. The coated print media typically includes a substrate and a porous ink-receiving layer deposited on the substrate. The substrate can be paper, plastic, coated paper, fabric, art paper, optical disks, or other known substrate used in the ink-jet printing arts. In one embodiment, photobase can be used as the substrate. Photobase is typically a three-layered system comprising a single layer of paper sandwiched by two polymeric layers, such as polyethylene layers.

With respect to the porous ink-receiving layer, inorganic semi-metal or metal oxide particulates, a polymeric binder, and optionally, mordants and/or other porous coating composition agents can be present. In one embodiment, the inorganic semi-metal or metal oxide particulates can be silica, alumina, boehmite, silicates (such as aluminum silicate, magnesium silicate, and the like), titania, zirconia, calcium carbonate, clays, and combinations thereof. In a more detailed aspect, the particulates can be alumina, silica, or aluminosilicate. Each of these inorganic particulates can be dispersed throughout a porous coating composition, which can be applied to a media substrate to form the porous ink-receiving layer. Typically, the inorganic particulates are present in the coating composition at from 60 wt % to 95 wt %. In a few specific embodiments, boehmite can be present in the coating composition at from 85 wt % to 95 wt %, or silica or silicates can be present in the coating composition at from 75 wt % to 85 wt %.

In order to bind the inorganic particulates together in the coating composition, a polymeric binder is typically included. Exemplary polymeric binders that can be used include polyvinyl alcohol including water-soluble copolymers thereof; polyvinyl acetate; polyvinyl pyrrolidone; modified starches including oxidized and etherified starches; water soluble cellulose derivatives including carboxymethyl cellulose, hydroxyethyl cellulose; polyacrylamide including its derivatives and copolymers; casein; gelatin; soybean protein; silyl-modified polyvinyl alcohol; conjugated diene copolymer latexes including maleic anhydride resin, styrene-butadiene copolymer, and the like; acrylic polymer latexes including polymers and copolymers of acrylic and methacrylic acids, and the like; vinyl polymer latexes including ethylene-vinyl acetate copolymers; functional group-modified latexes including those obtained by modifying the above-mentioned polymers with monomers containing functional groups (e.g. carboxyl, amino, amido, sulfo, etc.); aqueous binders of thermosetting resins including melamine resins, urea resins, and the like; synthetic resin binders including polymethyl methacrylates, polyurethane resins, polyester resins, amide resins, vinyl chloride-vinyl acetate copolymers, polyvinyl butyrals, and alkyl resins. Such binders can be present to bind the porous ink-receiving layer together, but can also be present in small enough amounts to maintain the porous nature of the porous ink-receiving layer. In accordance with embodiments of the present invention, the polymeric binder can be present in the coating composition at from 5 wt % to 40 wt %. In specific embodiments where boehmite is used, the polymeric binder can be present at from 3 wt % to 15 wt %. Alternatively, where silica or silicates are used, the polymeric binder can be present at from 10 wt % to 25 wt %. In another specific embodiment, the binder can be polyvinyl alcohol or derivatives thereof.

Optionally, the porous ink-receiving layer can also be modified with an ionic binding species or mordant known to interact with a predetermined class of colorants, thereby increasing permanence. Typical mordants that can be included in the coating composition (and thus, included in the porous ink-receiving layer) include hydrophilic, water dispersible, or water soluble polymers having cationic groups (amino, tertiary amino, amidoamino, pyridine, imine, and the like). These cationically modified polymers can be compatible with water-soluble or water dispersible binders and have little or no adverse effect on image processing or colors present in the image. Suitable examples of such polymers include, but are not limited to, polyquaternary ammonium salts, cationic polyamines, polyamidins, cationic acrylic copolymers, guanidine-formaldehyde polymers, polydimethyl diallylammonium chloride, diacetone acrylamide-dimethyldiallyl ammonium chloride, polyethyleneimine, and a polyethyleneimine adduct with epichlorhydrin. Aside from mordants, other optional components that can be present in the porous ink-receiving layer can include anionic surfactants, cationic surfactants, biocides, plasticizers, optical brighteners, viscosity modifiers, leveling agents, UV absorbers, hindered amine stabilizers, anti-ozonants, silane coupling agents, and/or other known additives.

The ink-receiving layer can be a single layer or a multilayer coating designed to absorb sufficient quantities of ink to produce high quality printed images. The coating composition may be applied to the media substrate to form the ink-receiving layer by any means known to one skilled in the art, including blade coating, air knife coating, rod coating, wire rod coating, roll coating, slot coating, slide hopper coating, gravure, curtain, and cascade coating. The ink-receiving layer can be printed on one or both sides of the media substrate. In one embodiment of the present invention, the depth of the ink-receiving layer formed by the coating composition can be from about 20 μm to about 60 μm. In accordance with a few specific embodiments, the thickness for boehmite-containing coating compositions can be from 40 μm to 55 μm, the thickness for silica- or silicate-containing coating compositions can be from 25 μm to 35 μm. If applied as a media topcoat, the thickness can range from 0.1 μm to 10 μm, and in a more specific embodiment, from 1 μm to 5 μm.

Discontinuous Film

The discontinuous film compositions that can be used to form the print media and printed images of the present invention are typically prepared as an aqueous coating composition which can include an amine, an amide, or combinations thereof; a latex; and a binder. The specific formulations for the aqueous coating composition are chosen such that, when applied, a discontinuous film is formed on the resulting print medium. The discontinuous film formed includes the amine and/or amide composition, latex particulates, and binder used to bind the composition together. Because of the discontinuous nature of the film, ink applied to the print medium can readily pass through the spaces in the discontinuous film to the ink-receiving layer. The ink is thus held at least partially within the ink-receiving layer, and is protected from ozone in the air by the amines and/or amides in the discontinuous film.

The aqueous coating composition, and thus the resulting discontinuous film, can include amines, amides, or combinations thereof. Any amine or amide known to one skilled in the art that can result in an increase in ozone fastness when present in the discontinuous film may be utilized, and is considered to be within the scope of the present invention. In one embodiment of the present invention, polyamines can be included in the aqueous coating composition. Effective polyamines include, but are not limited to, polymeric epoxy-amine adducts, oligomeric epoxy-amine adducts, aliphatic polyamines, aromatic polyamines, and combinations and mixtures thereof. In one embodiment, the amine formulation present in the aqueous coating composition comprises a mixture of an aliphatic polymeric amine and a polyetherdiamine. Commercial formulations that are similar to this embodiment, and that are considered to be within the scope of the present invention, include Anquamine 401® and Anquamine 419, manufactured by Air Products and Chemicals Inc. The formulation for Anquamine 401® includes an aliphatic polymeric amine, poly(oxo(methyl-1,2-ethanediyl), α-(2-aminomethyl)ethyl-ω-(2-aminomethylethoxy), and tetraethylenepentamine in water. The formulation for Anquamine 419® includes an epoxy-aliphatic polymeric amine adduct. Other commercial amines that are considered to be within the scope of the present invention include EpiCure 8535 and EpiCure 8536 from Resolution Performance Products, Inc. EpiCure 8535 is a modified aliphatic amine and polyethylene polyamine whereas EpiCure 8536 is a polyamido amine.

Amides can be utilized in the aqueous coating composition in conjunction with or in lieu of the amines noted above. In one embodiment, polyamides are included, an example of which include, without limitation, polyacrylamide.

The latex used in the aqueous coating composition includes a dispersion of latex particulates. In one embodiment, the latex includes latex particulates having a glass transition temperature from about −25° C. to about 100° C. In another embodiment, the latex includes latex particulates having a glass transition temperature from about 50° C. to about 100° C.

The following are examples of specific commercial latex formulations. This list is not meant to be limiting to the scope of the invention, but merely to provide information regarding possibly useful latexes. For example, Genflo 8045®, available from Omnova Solutions, Inc., is an anionic emulsion of carboxylated styrene butadiene polymer particulates with a glass transition temperature of about 54° C. Sunsphere latex, available from Rohm & Hass, is an acrylic hollow core specialty latex with a glass transition temperature greater than 50° C. Another example that is also available from Rohm & Haas is a cationic acrylic latex polymer having a glass transition temperature of 65-75° C. These and other latexes can be used to form the discontinuous film.

As mentioned, the aqueous coating composition can also include a binder. The binder can be any composition or compound known to one skilled in the art that can be used to functionally affix the amines and/or amides, as well as the latex particulates, to the porous ink-receptive layer. The amount and type of binder should be selected such that a discontinuous film, rather than a continuous film, is formed on the porous ink receptive layer, thus maintaining the porosity of the print medium. The physical configuration of the discontinuous layer with respect to the porous ink-receptive layer allows ink applied to the print medium to be received by the ink-receiving layer. A continuous film, on the other hand, would not allow the ink sufficient access to the porous ink-receiving layer.

The aqueous coating composition can be applied wet, and as it dries, the latex particulates coat the ink-receiving layer to form the discontinuous film. For the aqueous coating composition to form a discontinuous film, it should be applied to the ink-receiving layer at a temperature below the glass transition temperature of the latex particulates. In an alternative embodiment, additives can be included in the aqueous coating composition to inhibit continuous film formation at temperatures above the glass transition temperature of the latex particulates.

The aqueous coating composition can be applied to the ink-receiving layer to form the discontinuous film by any means known to one skilled in the art, including blade coating, air knife coating, rod coating, wire rod coating, roll coating, slot coating, slide hopper coating, gravure, curtain, and cascade coating. The aqueous coating composition can by applied to the ink-receiving layer such that voids are created that are interspersed throughout the resulting discontinuous film with an average size of from about 5 nm to about 25 nm, though these values may be highly variable, depending on the desired use. Further, the discontinuous film can be printed on one or both sides of the media substrate. In one embodiment, the aqueous coating composition can be applied such that the resulting discontinuous film has an average thickness from about 0.5 g/m² to about 12 g/m². In another embodiment, the discontinuous film can have an average thickness of from about 2 g/m² to about 6 g/m².

Ink-Jet Ink

The ink-jet ink compositions that can be used to form the printed images of the present invention are typically prepared in an aqueous formulation or liquid vehicle which can include water, colorants, cosolvents, surfactants, buffering agents, biocides, sequestering agents, viscosity modifiers, humectants, binders, and/or other known additives. In one aspect of the present invention, the liquid vehicle can comprise from about 70 wt % to about 99.9 wt % by weight of the ink-jet ink composition. In another aspect, the liquid vehicle can also carry polymeric binders, latex particulates, and/or other solids.

As described, cosolvents can be included in the ink-jet compositions of the present invention. Suitable cosolvents for use in the present invention include water soluble organic cosolvents, but are not limited to, aliphatic alcohols, aromatic alcohols, diols, glycol ethers, poly(glycol) ethers, lactams, formamides, acetamides, long chain alcohols, ethylene glycol, propylene glycol, diethylene glycols, triethylene glycols, glycerin, dipropylene glycols, glycol butyl ethers, polyethylene glycols, polypropylene glycols, amides, ethers, carboxylic acids, esters, organosulfides, organosulfoxides, sulfones, alcohol derivatives, carbitol, butyl carbitol, cellosolve, ether derivatives, amino alcohols, and ketones. For example, cosolvents can include primary aliphatic alcohols of 30 carbons or less, primary aromatic alcohols of 30 carbons or less, secondary aliphatic alcohols of 30 carbons or less, secondary aromatic alcohols of 30 carbons or less, 1,2-diols of 30 carbons or less, 1,3-diols of 30 carbons or less, 1,5-diols of 30 carbons or less, ethylene glycol alkyl ethers, propylene glycol alkyl ethers, poly(ethylene glycol) alkyl ethers, higher homologs of poly(ethylene glycol) alkyl ethers, poly(propylene glycol) alkyl ethers, higher homologs of poly(propylene glycol) alkyl ethers, lactams, substituted formamides, unsubstituted formamides, substituted acetamides, and unsubstituted acetamides. Specific examples of cosolvents that are preferably employed in the practice of this invention include, but are not limited to, 1,5-pentanediol, 2-pyrrolidone, 2-ethyl-2-hydroxymethyl-1,3-propanediol, diethylene glycol, 3-methoxybutanol, and 1,3-dimethyl-2-imidazolidinone. Cosolvents can be added to reduce the rate of evaporation of water in the ink-jet to minimize clogging or other properties of the ink such as viscosity, pH, surface tension, optical density, and print quality. The cosolvent concentration can range from about 5 wt % to about 25 wt %, and in one embodiment is from about 10 wt % to about 20 wt %. Multiple cosolvents can also be used, as is known in the art.

Various buffering agents or pH adjusting agents can also be optionally used in the ink-jet ink compositions of the present invention. Typical buffering agents include such pH control solutions as hydroxides of alkali metals and amines, such as lithium hydroxide, sodium hydroxide, potassium hydroxide; citric acid; amines such as triethanolamine, diethanolamine, and dimethylethanolamine; hydrochloric acid; and other basic or acidic components which do not substantially interfere with the bleed control or optical density characteristics of the present invention. If used, buffering agents typically comprise less than about 10 wt % of the ink-jet ink composition.

In another aspect of the present invention, various biocides can be used to inhibit growth of undesirable microorganisms. Several non-limiting examples of suitable biocides include benzoate salts, sorbate salts, commercial products such as NUOSEPT (Nudex, Inc., a division of Huls America), UCARCIDE (Union Carbide), VANCIDE (RT Vanderbilt Co.), and PROXEL (ICI Americas) and other known biocides. Typically, such biocides comprise less than about 5 wt % of the ink-jet ink composition and often from about 0.1 wt % to about 0.25 wt %.

In an additional aspect of the present invention, binders can be included which act to protect the colorants on the substrate. Binders suitable for use in the present invention typically have a molecular weight of from about 500 Mw to about 5,000 Mw. Non-limiting examples include polyester, polyester-melanine, styrene-acrylic acid copolymers, styrene-acrylic acid-alkyl acrylate copolymers, styrene-maleic acid copolymers, styrene-maleic acid-alkyl acrylate copolymers, styrene-methacrylic acid copolymers, styrene-methacrylic acid-alkyl acrylate copolymers, styrene-maleic half ester copolymers, vinyl naphthalene-acrylic acid copolymers, vinyl naphthalene-maleic acid copolymers, and salts thereof.

If surfactants are used, then typical water-soluble surfactants such as alkyl polyethylene oxides, alkyl phenyl polyethylene oxides, polyethylene oxide (PEO) block copolymers, acetylenic PEO, PEO esters, PEO amines, PEO amides, and dimethicone copolyols can be used. Such surfactants can be present at from 0.01% to about 10% by weight of the ink-jet ink composition.

Colorants included in the ink-jet ink of the printed image embodiment of the present invention can be dyes. With respect to the various ink-jet ink dyes, either a cationic dye or an anionic dye can be used. In one embodiment of the present invention, the anionic dye can be a chromaphore having a pendent anionic group. Though any effective amount of dye can be used, preferably, the anionic dye can be present in the ink composition at from about 0.1 wt % to about 10 wt %. Examples of suitable anionic dyes that can be used include a large number of water-soluble acid and direct dyes. Specific examples of anionic dyes include Direct Yellow 86, Acid Red 249, Direct Blue 199, Direct Black 168, Reactive Black 31, Direct Yellow 157, Reactive Yellow 37, Acid Yellow 23, Reactive Red 180, Acid Red 52, Acid Blue 9, Direct Red 227, Acid Yellow 17, Direct Blue 86, Reactive Red 4, Reactive Red 56, Reactive Red 31, and Direct Yellow 132; Aminyl Brilliant Red F-B (Sumitomo Chemical Co.); the Duasyn line of “salt-free” dyes available from Hoechst; mixtures thereof; and the like. Further examples include Bernacid Red 2BMN, Pontamine Brilliant Bond Blue A, BASF X-34, Pontamine, Food Black 2, Levafix Brilliant Red E-4B (Mobay Chemical), Levafix Brilliant Red E-6BA (Mobay Chemical), Pylam Certified D&C Red #28 (Acid Red 92, Pylam), Direct Brill Pink B Ground Crude (Crompton & Knowles), Cartasol Yellow GTF Presscake (Sandoz, Inc.), Tartrazine Extra Conc. (FD&C Yellow #5, Acid Yellow 23, Sandoz, Inc.), Cartasol Yellow GTF Liquid Special 110 (Sandoz, Inc.), D&C Yellow #10 (Yellow 3, Tricon), Yellow Shade 16948 (Tricon), Basacid Black X34 (BASF), Carta Black 2GT (Sandoz, Inc.), Neozapon Red 492 (BASF), Orasol Red G (Ciba-Geigy), Direct Brilliant Pink B (Crompton-Knolls), Aizen Spilon Red C-BH (Hodagaya Chemical Company), Kayanol Red 3BL (Nippon Kayaku Company), Levanol Brilliant Red 3BW (Mobay Chemical Company), Levaderm Lemon Yellow (Mobay Chemical Company), Aizen Spilon Yellow C-GNH (Hodagaya Chemical Company), Spirit Fast Yellow 3G, Sirius Supra Yellow GD 167, Cartasol Brilliant Yellow 4GF (Sandoz), Pergasol Yellow CGP (Ciba-Geigy), Orasol Black RL (Ciba-Geigy), Orasol Black RLP (Ciba-Geigy), Savinyl Black RLS (Sandoz), Dermacarbon 2GT (Sandoz), Pyrazol Black BG (ICI Americas), Morfast Black Conc A (Morton-Thiokol), Diazol Black RN Quad (ICI Americas), Orasol Blue GN (Ciba-Geigy), Savinyl Blue GLS (Sandoz, Inc.), Luxol Blue MBSN (Morton-Thiokol), Sevron Blue 5GMF (ICI Americas), and Basacid Blue 750 (BASF); Levafix Brilliant Yellow E-GA, Levafix Yellow E2RA, Levafix Black EB, Levafix Black E-2G, Levafix Black P-36A, Levafix Black PN-L, Levafix Brilliant Red E6BA, and Levafix Brilliant Blue EFFA, all available from Bayer; Procion Turquoise PA, Procion Turquoise HA, Procion Turquoise Ho5G, Procion Turquoise H-7G, Procion Red MX-5B, Procion Red MX 8B GNS, Procion Red G, Procion Yellow MX-8G, Procion Black H-EXL, Procion Black P-N, Procion Blue MX-R, Procion Blue MX-4GD, Procion Blue MX-G, and Procion Blue MX-2GN, all available from ICI Americas; Cibacron Red F-B, Cibacron Black BG, Lanasol Black B, Lanasol Red 5B, Lanasol Red B, and Lanasol Yellow 46, all available from Ciba-Geigy; Baslien Black P-BR, Baslien Yellow EG, Baslien Brilliant Yellow P-3GN, Baslien Yellow M-6GD, Baslien Brilliant Red P-3B, Baslien Scarlet E-2G, Baslien Red E-B, Baslien Red E-7B, Baslien Red M-5B, Baslien Blue E-R, Baslien Brilliant Blue P-3R, Baslien Black P-BR, Baslien Turquoise Blue P-GR, Baslien Turquoise M-2G, Baslien Turquoise E-G, and Baslien Green E-6B, all available from BASF; Sumifix Turquoise Blue G, Sumifix Turquoise Blue H-GF, Sumifix Black B, Sumifix Black H-BG, Sumifix Yellow 2GC, Sumifix Supra Scarlet 2GF, and Sumifix Brilliant Red 5BF, all available from Sumitomo Chemical Company; Intracron Yellow C-8G, Intracron Red C-8B, Intracron Turquoise Blue GE, Intracron Turquoise HA, and Intracron Black RL, all available from Crompton and Knowles, Dyes and Chemicals Division; Pro-Jet 485 (a copper phthalocyanine); Magenta 377; mixtures thereof, and the like. This list is intended to be merely exemplary, and should not be considered limiting.

### EXAMPLES

The following examples illustrate the embodiments of the invention that are presently best known. However, it is to be understood that the following are only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following examples provide further detail in connection with what are presently deemed to be the most practical and preferred embodiments of the invention. Also, each additive of these examples is described in accordance with its solids content by weight.

### Example 1

### Preparation of Silica-Based Porous Coating Composition

A silica-based porous coating composition is prepared in accordance with the formulation of Table 1, as follows:

TABLE 1

| Ingredient | Parts by weight |
|---|---|
| 0.2 μm porous Silica | 100 |
| (Grace Davison) | |
| Polyvinyl alcohol | 26 |
| (Airproducts Airvol 350) | |
| Acrylic polymer | 5 |
| (Dow XUR 1540 2494-6) | |
| Water | Balance to achieve 17 wt % solids |

### Example 2

### Preparation of Aqueous Overcoat Composition

Three aqueous overcoat compositions are prepared according to the following formulations, as shown in Tables 2-4 below:

TABLE 2

| Ingredient | Wt % of stock solution | Wt % in dried coating |
|---|---|---|
| Anquamine 401 | 20% aqueous | 60% |
| (Air Products) | | |
| Genflo 8045 | 51.5% | 39.6% |
| (Omnova) | | |
| Zonyl FSA | 5% aqueous | 0.4% |
| (Du Pont) | | |

TABLE 3

| Ingredient | Wt % of stock solution | Wt % in dried coating |
|---|---|---|
| Anquamine 401 | 20% aqueous | 60% |
| (Air Products) | | |
| Sunsphere Latex | 27% | 40.6% |
| (Rohm & Haas) | | |

TABLE 4

| | Wt % of stock | |
|---|---|---|
| Ingredient | solution | Wt % in dried coating |
| Anquamine 401 | 20% aqueous | 50% |
| (Air Products) | | |
| Cationic Acrylic Latex | 35.89% | 49.6% |
| (Rohm & Haas) | | |
| Zonyl FSA | 5% aqueous | 0.4% |
| (Du Pont) | | |

In each of the above aqueous overcoat compositions, the ingredients are mixed in water by adding each of the ingredients such that 10 wt % solids is present. Each of these aqueous overcoat compositions can be applied to a porous ink-receiving layer, such as a silica- or alumina-based ink-receiving layer using a known coating method to form a discontinuous film having a coat weight from about 2.0 to 6.0 g/m², for example.

### Example 4

### Application of Base Coating and Aqueous Overcoat Compositions to Media Substrate

The silica-based porous coating composition of Example 1 is applied to three separate media substrates (Samples A, B, and C). The application in each case is conducted using a Meyer rod at a delivery rate of 32 g/m², and the porous coating compositions are dried in an oven at 60° C. Sample A is coated with the aqueous overcoat composition of Example 3, Table 2. Sample B is coated with the aqueous overcoat composition of Example 3, Table 3. Sample C is coated with the aqueous overcoat composition of Example 3, Table 4. All three print media samples are coated with their respective aqueous overcoat composition using a Meyer rod at a delivery rate of 4 g/m². The resulting print media are then dried for 24 hours at ambient temperature and at 50% relative humidity.

### Example 5

### Preparation of Test Prints

Diagnostic images are prepared using inks containing cyan, magenta, and yellow dyes, by ink-jetting cyan, magenta, and yellow colored blocks of increasing optical density on each of the three print media sheets described in Example 4 (A-C), using an HP DeskJet 970 printer. A control series of images is also prepared by ink-jetting cyan, magenta, and yellow colored blocks of increasing optical density to silica-based porous media that is devoid of a discontinuous film.

### Example 6

### Print Test Results

The diagnostic images and the control images prepared in Example 5 are exposed to ozone gas in a Hampden 903 Ozone Test Chamber at 30° C., 50% RH, and 0.5 ppm (v/v) ozone level. The diagnostic prints are used to evaluate ozone fastness by examining the % change over time from the initial optical density. The dye failure criteria as defined by Wilhelm Research were used, and the values are described in Table 5 as follows:

TABLE 5

| Dye Color | Initial O.D. | % loss of O.D. for failure | O.D. at failure |
|---|---|---|---|
| Cyan | 0.50 | 30% | 0.350 |
| Magenta | 0.50 | 25% | 0.375 |
| Yellow | 0.50 | 35% | 0.325 |

The results related to ozone fade of the inks printed on each media sample are set forth in Table 6, as follows:

TABLE 6

| | Failure Time (hr) | | |
|---|---|---|---|
| Coating | Cyan | Magenta | Yellow |
| Control | 8 | 4 | 114 |
| Sample A | 242 | 32 | 816 |
| Sample B | 222 | 30 | 612 |
| Sample C | 80 | 12 | 246 |

As can be seen in Table 6, the coated print media having a discontinuous film as prepared in Tables 2-4 require much longer exposure to ozone gas to cause dye failure, thus demonstrating the improved ozone fastness characteristics of porous printed media coated with the above noted discontinuous film formulations.

Similar results are achieved using three alumina-based ink-receiving layer-coated media sheets (Samples D-F) rather than the silica-based ink-receiving layer, each being coated with the same aqueous overcoat compositions described in Tables 2-4. In other words, Samples A, B, and C are identically prepared with respect to Samples D, E, and F, respectively, except that an alumina-based ink-receiving layer was applied to the media substrate rather than the silica-based ink-receiving layer of Example 1. Thus, Sample A (silica) corresponds with Sample D (alumina), Sample B (silica) corresponds to Sample E (alumina), and Sample C (silica) corresponds with Sample F (alumina). The results related to ozone fade results of inks printed on alumina-based porous media are set forth in Table 7, as follows:

TABLE 7

| | Failure Time (hr) | | |
|---|---|---|---|
| Media | Cyan | Magenta | Yellow |
| Control | 10 | 4 | 100 |
| Sample D | 236 | 42 | 926 |
| Sample E | 218 | 70 | 974 |
| Sample F | 106 | 38 | 388 |

Again, as can be seen in Table 7, the coated print media having a discontinuous film as prepared in Tables 2-4 require much longer exposure to ozone gas to cause dye failure, thus demonstrating the improved ozone fastness characteristics of porous printed media coated with the above noted discontinuous film formulations.

While the invention has been described with reference to certain preferred embodiments, those skilled in the art will appreciate that various modifications, changes, omissions, and substitutions can be made without departing from the spirit of the invention. It is therefore intended that the invention be limited only by the scope of the appended claims.

1. A method of producing a print medium, comprising steps of:
a) coating a media substrate with a porous coating composition to form a porous ink receiving layer, said porous coating composition including metal or semi-metal oxide particulates;
b) coating the porous ink-receiving layer with an aqueous overcoat composition to form a discontinuous film configured with pores to allow an ink to be received at the porous ink-receiving layer, said aqueous overcoat composition comprising:
i) an amine, an amide, or combinations thereof;
ii) a latex, and
iii) a binder.

2. A method as in claim 1, wherein the discontinuous film has an average pore size form about 5 nm to 25 nm.

3. A method as in claim 1, wherein the latex includes latex particulates having a glass transition temperature from about −25° C. to about 100° C.

4. A method as in claim 4, wherein the latex includes latex particulates having a glass transition temperature from about 50° C. to about 100° C.

5. A method as in claim 1, wherein the amine is a polyamine.

6. A method as in claim 5, wherein the polyamine is selected from the group consisting of a polymeric epoxy-amine adduct, an oligomeric epoxy-amine adduct, an aliphatic polyamine, an aromatic polyamine, and mixtures thereof.

7. A method as in claim 6, wherein the amine comprises a mixture of an aliphatic polymeric amine and a polyetherdiamine.

8. A method as in claim 1, wherein the amide is a polyamide.

9. A method as in claim 8, wherein the amide is a polyacrylamide.

10. A method as in claim 1, wherein the discontinuous film has an average thickness from about 0.5 g/m² to about 12 g/m².

11. A method as in claim 10, wherein the discontinuous film has an average thickness of from about 2 g/m² to about 6 g/m².

12. A print medium, comprising:
a) a media substrate;
b) a porous ink-receiving layer coated on the media substrate, said porous ink-receiving layer including metal or semi-metal oxide particulates; and
c) a discontinuous film coated on the porous ink-receiving layer and configured with pores to allow an ink to be received at the porous ink-receiving layer, said discontinuous film comprising:
i) an amine, an amide, or combinations thereof,
ii) latex particulates, and
ii) a binder.

13. A print medium as in claim 12, wherein the discontinuous film has an average pore size form about 5 nm to 25 nm.

14. A print medium as in claim 12, wherein the latex includes latex particulates having a glass transition temperature from about −25° C. to about 100° C.

15. A print medium as in claim 14, wherein the latex includes latex particulates having a glass transition temperature from about 50° C. to about 100° C.

16. A print medium as in claim 12, wherein the amine is a polyamine.

17. A print medium as in claim 16, wherein the polyamine is selected from the group consisting of a polymeric epoxy-amine adduct, an oligomeric epoxy-amine adduct, an aliphatic polyamine, an aromatic polyamine, and mixtures thereof.

18. A print medium as in claim 17, wherein the amine comprises a mixture of an aliphatic polymeric amine and a polyetherdiamine.

19. A print medium as in claim 12, wherein the amide is a polyamide.

20. A print medium as in claim 19, wherein the amide is a polyacrylamide.

21. A print medium as in claim 12, wherein the discontinuous film has an average thickness from about 0.5 g/m² to about 12 g/m².

22. A print medium as in claim 21, wherein the discontinuous film has an average thickness of from about 2 g/m² to about 6 g/m².

23. A printed image on a print medium, comprising:
a) a media substrate;
b) a porous ink-receiving layer coated on the media substrate, said porous ink-receiving layer including metal or semi-metal oxide particulates;
c) a discontinuous film coated on the porous ink-receiving layer and configured with pores to allow an ink to be received at the porous ink-receiving layer, said discontinuous film, comprising:
i) an amine, an amide, or combinations thereof,
ii) latex particulates, and
ii) a binder; and
d) an ink-jet ink printed on at least a portion of the discontinuous film and received by the porous ink-receiving layer.

24. A printed image as in claim 23, wherein the discontinuous film has an average pore size form about 5 nm to 25 nm.

25. A printed image as in claim 23, wherein the latex includes latex particulates having a glass transition temperature from about −25° C. to about 100° C.

26. A printed image as in claim 25, wherein the latex includes latex particulates having a glass transition temperature from about 50° C. to about 100° C.

27. A printed image as in claim 23, wherein the amine is a polyamine.

28. A printed image as in claim 27, wherein the polyamine is selected from the group consisting of a polymeric epoxy-amine adduct, an oligomeric epoxy-amine adduct, an aliphatic polyamine, an aromatic polyamine, and mixtures thereof.

29. A printed image as in claim 28, wherein the amine comprises a mixture of an aliphatic polymeric amine and a polyetherdiamine.

30. A printed image as in claim 23, wherein the amide is a polyamide.

31. A printed image as in claim 30, wherein the amide is a polyacrylamide.

32. A printed image as in claim 23, wherein the discontinuous film has an average thickness of from about 0.5 g/m² to about 12 g/m².

33. A printed image as in claim 32, wherein the discontinuous film has an average thickness of from about 2 g/m² to about 6 g/m².
